(19) United States
(12) Patent Application Publication
(10) Pub. No.: US 2023/0251373 A1
(43) Pub. Date: Aug. 10, 2023

(54) RANGING METHOD, APPARATUS AND SYSTEM, INTELLIGENT DEVICE AND COMPUTER-READABLE STORAGE MEDIUM

(71) Applicant: SUZHOU TOUCHAIR TECHNOLOGY CO., LTD, Suzhou (CN)

(72) Inventors: Guangsong Liu, Suzhou (CN); Weichen Xiang, Suzhou (CN)

(21) Appl. No.: 18/134,369

(22) Filed: Apr. 13, 2023

Related U.S. Application Data
(63) Continuation of application No. PCT/CN2020/137437, filed on Dec. 18, 2020.

(30) Foreign Application Priority Data
Nov. 24, 2020 (CN) 202011329162.1

(51) Int. Cl. G01S 15/10

(52) U.S. Cl. CPC G01S 15/104

(57) ABSTRACT

The present application provides a ranging method, apparatus and system, an intelligent device and a computer-readable storage medium. The ranging method is applicable to a first device, and the ranging method includes: transmitting a first acoustic positioning signal; receiving the first acoustic positioning signal. Regardless of whether the clock timestamps between devices are synchronized and whether the response time of software processing is different, the present application can achieve high positioning accuracy.

### CROSS REFERENCE TO RELATED APPLICATIONS

The present application is a Continuation application of PCT Application No. PCT/CN2020/137437 filed on Dec. 18, 2020, which claims the benefit of Chinese Patent Application No. 202011329162.1 filed on Nov. 24, 2020. All the above are hereby incorporated by reference in their entirety.

### TECHNICAL FIELD

The present application relates to the technical field of distance measurement, in particular to a ranging method, apparatus and system, an intelligent device and a computer-readable storage medium.

### BACKGROUND

From Location Based Service (LBS) to Internet of Things, the mobile internet has firmly grasped the interaction between people and scenes, bringing clothing, food, housing and transportation into online and offline services, and bringing convenience to the public. However, the current application of positioning technology in intelligent hardware mostly attempts to obtain the absolute position of the intelligent hardware, and then compare it with the digital map to determine the position of the intelligent hardware. However, in terms of practical application, the positioning of the relative position between people is more valuable and practical than the absolute position. Because the absolute position can only identify the relationship between specific people and objects, the difficulty of acquisition is great and the speed of acquisition relatively slow. However, for users who do not depend on the absolute position in many cases, the interaction of relative position has met the business needs. For example, in the field of smart home, the size and direction of voice can be adjusted intelligently as the user's position changes, and the relative position of the user and the smart speaker can meet the needs. This is undoubtedly a great opportunity.

At present, for the relative positioning between intelligent devices, the GNSS global satellite positioning system is generally used outdoors, while the UWB technology, infrared technology, WiFi technology, Bluetooth technology and so on are used indoors.

However, the positioning accuracy of the GNSS global satellite positioning system is low, and it can hardly be used indoors. The WiFi technology and Bluetooth technology are not accurate in determining the relative position of intelligent devices, and also need to repeatedly test and compare the actual distance to obtain the signal strength and environmental attenuation factor when one meter away from the Bluetooth device, so they are not reliable. The infrared technology and laser technology are vulnerable to environmental light interference and are also unreliable. The UWB technology requires that the intelligent devices must carry UWB positioning chip accessories, thus not possessing the universality.

### SUMMARY

The embodiments of the present application provide a ranging method, apparatus and system, an intelligent device and a computer-readable storage medium.

The embodiments of the present application adopt the following technical solution:

A ranging method, wherein the ranging method is applicable to a first device and the ranging method includes:

transmitting a first acoustic positioning signal;
receiving the first acoustic positioning signal;
receiving a notification message containing a first time difference between first time that a second device receives a second acoustic positioning signal and second time that the second device receives the first acoustic positioning signal, the second acoustic positioning signal being transmitted by the second device;
receiving the second acoustic positioning signal;
determining a second time difference between third time that the first device receives the second acoustic positioning signal and fourth time that the first device receives the first acoustic positioning signal; and
determining a distance between the first device and the second device based on the first time difference and the second time difference.

In an embodiment, the method further includes:

before the step of transmitting the first acoustic positioning signal, transmitting a ranging start signal and enabling an acoustic recording function of the first device, so that an acoustic recording function of the second device is enabled when the second device receives the ranging start signal.

In an embodiment, the method further includes:

determining the first time difference based on a point number difference between a sampling point that the second device receives the second acoustic positioning signal in a recording file generated by the acoustic recording function of the second device and a sampling point that the second device receives the first acoustic positioning signal in the recording file generated by the acoustic recording function of the second device, and a predetermined sampling frequency; and
determining the second time difference based on a point number difference between a sampling point that the first device receives the second acoustic positioning signal in a recording file generated by the acoustic recording function of the first device and a sampling point that the first device receives the first acoustic positioning signal in the recording file generated by the acoustic recording function of the first device, and a predetermined sampling frequency.

In an embodiment, the second acoustic positioning signal is transmitted by the second device after receiving the first acoustic positioning signal; or the second acoustic positioning signal is transmitted by the second device at a predetermined time point.

In an embodiment, the step of determining a distance between the first device and the second device based on the first time difference and the second time difference includes:

determining the distance D, wherein D≈½*c*(T1−T2), where T1 is the second time difference, T2 is the first time difference and c is sound velocity.

A ranging apparatus, wherein the ranging apparatus is contained in a first device and the ranging apparatus includes:

a transmitting module configured to transmit a first acoustic positioning signal;
a receiving module configured to receive the first acoustic positioning signal; receive a notification message containing a first time difference between first time that a second device receives a second acoustic positioning signal and second time that the second device receives the first acoustic positioning signal, the second acoustic positioning signal being transmitted by the second device; and receive the second acoustic positioning signal; and
a determination module configured to determine a second time difference between third time that the first device receives the second acoustic positioning signal and fourth time that the first device receives the first acoustic positioning signal; and determine a distance between the first device and the second device based on the first time difference and the second time difference.

In an embodiment, the transmitting module is further configured to, before transmitting the first acoustic positioning signal, transmit a ranging start signal and enable an acoustic recording function of the first device, so that an acoustic recording function of the second device is enabled when the second device receives the ranging start signal; and/or

the determination module is further configured to determine the distance D, wherein D≈½*c*(T1−T2), where T1 is the second time difference, T2 is the first time difference and c is sound velocity.

A ranging system, wherein the ranging system includes:

a first device configured to transmit a first acoustic positioning signal and receive the first acoustic positioning signal; and
a second device configured to receive the first acoustic positioning signal, transmit a second acoustic positioning signal, receive the second acoustic positioning signal, and transmit to the first device a notification message containing a first time difference between first time that the second device receives the second acoustic positioning signal and second time that the second device receives the first acoustic positioning signal, wherein
the first device is further configured to receive the second acoustic positioning signal, determine a second time difference between third time that the first device receives the second acoustic positioning signal and fourth time that the first device receives the first acoustic positioning signal, and determine a distance between the first device and the second device based on the first time difference and the second time difference.

An intelligent device, wherein the intelligent device includes a processor and a memory;

the memory stores an application program capable of being executed by the processor to enable the processor to execute the ranging method.

A computer-readable storage medium, wherein the computer-readable storage medium stores a computer program, which, when executed by a processor, implements the ranging method.

From the above technical solution, it can be seen that in the embodiments of the present application, a first acoustic positioning signal is transmitted; the first acoustic positioning signal is received; a notification message containing a first time difference between first time that a second device receives a second acoustic positioning signal and second time that the second device receives the first acoustic positioning signal, wherein the second acoustic positioning signal is transmitted by the second device; the second acoustic positioning signal is received; a second time difference between third time that the first device receives the second acoustic positioning signal and fourth time that the first device receives the first acoustic positioning signal is determined; a distance between the first device and the second device is determined based on the first time difference and the second time difference. Therefore, the present application provides a static ranging method between intelligent devices, i.e., a two-way ranging technology based on time of flight, which realizes time-synchronization-free distance measurement. In the whole positioning process, the present application does not need to synchronize the clocks between the devices. Regardless of whether the clocks are accurate and whether the response time of the devices is different, the error caused thereby will be filtered out because of the difference, so the positioning accuracy is more accurate than the positioning method in which a synchronization process is adopted.

In addition, considering the acoustic receiver (such as microphone) and acoustic transmitter (such as speaker) that are generally provided in the intelligent device, the distance between two devices can be determined without requiring additional components.

### DESCRIPTION OF THE DRAWINGS

FIG. 1 illustrates an exemplary flowchart of a ranging method between intelligent devices according to the present application.

FIG. 2 illustrates an exemplary interaction diagram of a ranging process between intelligent devices according to the present application.

FIG. 3 illustrates a schematic diagram of receiving signals by intelligent devices according to the present application.

FIG. 4 illustrates an exemplary structural diagram of a ranging apparatus between intelligent devices.

FIG. 5 illustrates an exemplary structural diagram of a ranging system between intelligent devices.

### DESCRIPTION OF THE EMBODIMENTS

In order to make the purpose, technical solution and advantages of the present application clearer, the present application will be further described below in detail with reference to the drawings.

In order to make the description simple and intuitive, the solution of the present application will be described below by describing several representative embodiments. A large number of details in the embodiments are only used for helping understand the solution of the present application. However, it is obvious that the implementation of the technical solution of the present application is not limited to these details. In order to avoid unnecessarily blurring the solution of the present application, some embodiments are not described in detail, but are generally described. In the following, “including” refers to “including but not limited to”, and “according to . . . ” refers to “at least according to . . . , but not limited to only according to . . . ”. Due to the language habit of Chinese, in a case that the number of a component is not specifically indicated below, it means that the number of the component may be one or more, or it may be understood as at least one.

In the embodiment of the present application, a two-way distance measurement technology based on Time Of Flight (TOF) is realized, which is free of time synchronization, applies the acoustic receiver (such as microphone) and acoustic transmitter (such as speaker) generally provided in the intelligent device, and realizes the measurement of the distance between two relatively static (or relatively moving at speed of less than 5 m/s) intelligent devices without requiring additional components.

Moreover, in the embodiment of the present application, the microphone recording system of the intelligent device can be used for accurately calculating the response time of the device. In addition, the response mechanism of the intelligent device is added. Through Bluetooth, infrared or WiFi, mobile communication network, or direct acoustic modulation, the positioned device transmits the signal processing time to the positioning device, so that the positioning accuracy can be improved, and the positioning results are accurate and reliable. In addition, the present application does not need to synchronize the clocks between the devices in the whole positioning process, so regardless of whether the clock marks (time stamps) of the two devices are accurately synchronized, whether the response time of the device software processing is different and the like, the error caused thereby will be filtered out due to the calculation method provided in the present application, so that the positioning accuracy that can be achieved by the synchronous clock system (or the integrated transceiver system) can be achieved.

First of all, intelligent device refers to any kind of device, apparatus or machine with computing processing capability. Specifically, the intelligent device may include an acoustic transmitting module, an acoustic receiving module and a signal processing module. For example, is may be implemented as a smart phone, tablets, a smart watch, a smart television, etc., which can be used for transmitting and receiving acoustic positioning signals.

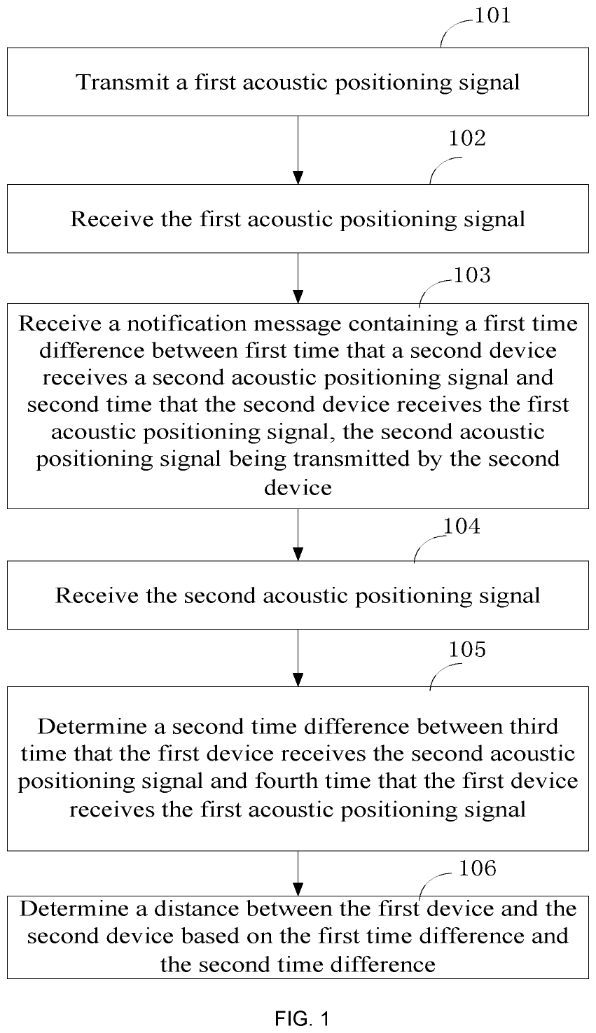

FIG. 1 illustrates an exemplary flowchart of a ranging method between intelligent devices according to the present application. The ranging method is applicable to a first device.

Referring to FIG. 1, the ranging method includes the following steps:

In step 101, a first acoustic positioning signal is transmitted.

In step 102, the first acoustic positioning signal is received.

In step 103, a notification message containing a first time difference between first time that a second device receives a second acoustic positioning signal and second time that the second device receives the first acoustic positioning signal is received. The second acoustic positioning signal is transmitted by the second device.

In step 104, the second acoustic positioning signal is received.

In step 105, a second time difference between third time that the first device receives the second acoustic positioning signal and fourth time that the first device receives the first acoustic positioning signal is determined.

In step 106, a distance between the first device and the second device is determined based on the first time difference and the second time difference.

The first acoustic positioning signal and the second acoustic positioning signal are exemplarily implemented as ultrasonic signals.

In an embodiment, before step 101 of transmitting the first acoustic positioning signal, a ranging start signal is transmitted and an acoustic recording function of the first device is enabled, so that an acoustic recording function of the second device is enabled when the second device receives the ranging start signal.

In an embodiment, the ranging method further includes: determining the first time difference based on a point number difference between a sampling point that the second device receives the second acoustic positioning signal in a recording file generated by the acoustic recording function of the second device and a sampling point that the second device receives the first acoustic positioning signal in the recording file generated by the acoustic recording function of the second device, and a predetermined sampling frequency.

In an embodiment, the ranging method further includes: determining the second time difference based on a point number difference between a sampling point that the first device receives the second acoustic positioning signal in a recording file generated by the acoustic recording function of the first device and a sampling point that the first device receives the first acoustic positioning signal in the recording file generated by the acoustic recording function of the first device, and a predetermined sampling frequency.

The sampling frequency of the first device and the sampling frequency of the second device may be the same or different.

In an embodiment, the second acoustic positioning signal is transmitted by the second device after receiving the first acoustic positioning signal. In an embodiment, the second acoustic positioning signal is transmitted by the second device at a predetermined time point.

In a case that the second acoustic positioning signal is transmitted after the second device receives the first acoustic positioning signal, the first time difference is positive. In a case that a predetermined time point that the second device transmits the second acoustic positioning signal is before the time that the second device receives the first acoustic positioning signal, the first time difference is negative. Similarly, in a case that the first device has received the first acoustic positioning signal before receiving the second acoustic positioning signal, the second time difference is positive; in a case that the first device receives the first acoustic positioning signal after receiving the second acoustic positioning signal, the second time difference is negative.

In an embodiment, the step of determining a distance between the first device and the second device based on the first time difference and the second time difference includes:

determining the distance D, wherein D≈½*c*(T1−T2), where T1 is the second time difference, T2 is the first time difference and c is sound velocity.

The present application will be exemplarily described below.

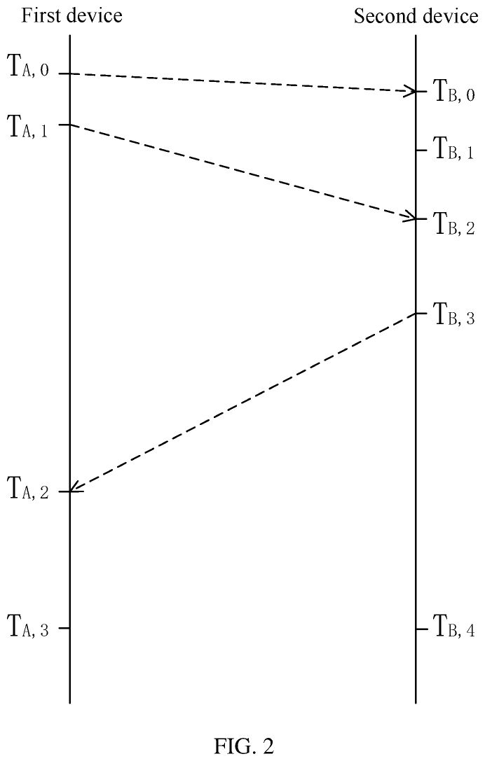

FIG. 2 illustrates an exemplary interaction diagram of a ranging process between intelligent devices according to the present application.

Based on the flowchart illustrated in FIG. 2, ranging between the first device and the second device can be implemented. The first device and the second device respectively include an acoustic transmitting module, an acoustic receiving module and a signal processing module. The first device and the second device are exemplarily intelligent devices, such as smart phones, tablets, smart watches, or smart televisions.

Specifically, the acoustic transmission module may include a speaker configured to transmit an acoustic positioning signal, which contains a unique identifier of the intelligent device (such as MAC address) and is a signal based on Code Division Multiple Access (CDMA) technology architecture. Exemplarily, the first device and the second device can transmit coded pulses of different frequency carriers respectively. For example, the frequency of the first acoustic positioning signal is 20 kHz and the frequency of the second acoustic positioning signal is 22 kHz, so as to improve the anti-interference ability of the system. The acoustic receiving module may include a microphone and a recording unit configured to receive the acoustic positioning signal and accurately record the arrival time of the signal.

In step 1, a recording duration to is set (such as 5 s).

In step 2, a first device transmits a ranging start signal to a second device through communication methods such as radio, Bluetooth, WiFi, mobile communication network or acoustic wave (acoustic code data interaction communication). The transmission time is recorded as time T_{A,0}. At the same time, the first device turns on its own acoustic receiving module (typically, it may be a microphone built in the first device). The microphone of the first device is always in a monitoring and recording state from the beginning of time T_{A,0} to the end of monitoring/recording as the recording duration is reached.

In step 3, the second device receives the ranging start signal transmitted by the first device and the time is recorded as time T_{B,0}. At this time, the second device turns on its own acoustic receiving module (typically, it may be a microphone built in the second device). The microphone of the second device is always in a monitoring and recording state from the beginning of time T_{B,0} to the end of monitoring/recording as the recording duration is reached.

In step 4, the first device transmits a first acoustic positioning signal. The first acoustic positioning signal contains a unique identifier of the first device (such as MAC address). The first acoustic positioning signal has a characteristic pulse peak (usually pulse width less than 100 us) for marking the signal time. Moreover, the first acoustic positioning signal is recorded by the acoustic receiving module of the first device. A signal processing module of the first device calculates a corresponding relevant pulse peak position. The time is marked as time T_{A,1}.

In step 5, the second device receives the first acoustic positioning signal. A signal processing module of the second device calculates the unique identifier and the relevant characteristic pulse peak position in the first acoustic positioning signal. The time is marked as time T_{B,2}.

In step 6, the second device transmits a second acoustic positioning signal. The second acoustic positioning signal contains a unique identifier of the second device (such as MAC address). The second acoustic positioning signal has a characteristic pulse peak (usually pulse width less than 100 us) for marking the signal time. Moreover, the second acoustic positioning signal is recorded by the acoustic receiving module of the second device. The signal processing module of the second device calculates the relevant characteristic pulse peak position in the second acoustic positioning signal. The time is marked as time T_{B,3}. The second device transmits a difference (T_{B,3}−T_{B,2}) between the signal transmitting time and the signal receiving time to the first device through communication methods such as radio, Bluetooth, WiFi, mobile communication network or acoustic wave (acoustic coded data interaction communication).

In step 7, the first device receives the second acoustic positioning signal, and receives the difference (T_{B,3}−T_{B,2}) between the signal receiving time and the signal transmitting time of the second device. The signal processing module of the first device calculates the unique identifier and the relevant characteristic pulse peak position in the second acoustic positioning signal. The time is marked as time T_{A,2}.

In step 8, the predetermined recording duration of the first device and the second device ends, and the end time is respectively recorded as T_{A3} and T_{B4}. The predetermined recording duration t₀=T_{A,3}−T_{A,0}=T_{B,4}−T_{B,0}.

In step 9, the first device calculates a distance D between the first device and the second device. The process specifically includes: firstly calculating the time of flight of the signal TOF=(T_{A,2}−T_{A,3})−(T_{B,3}−T_{B,2}); then calculating the distance D≈½*c*TOF between the two devices, where c is sound velocity.

In the whole positioning process, there are possible variables (T_{A,1}−T_{A,0}) and (T_{B,1}−T_{B,0}), that is, the time to start the microphones and speakers of the devices. However, since there is no need to synchronize the clocks between the devices, regardless of whether the clocks are accurate, whether the response time of the devices is different and the like, the error caused thereby will be filtered out due to the difference.

It is be understood that in one embodiment, the time T_{B,3} that the second device transmits the second acoustic positioning signal is later than the time that the signal processing module of the second device calculates the first acoustic positioning signal. In another embodiment, the time T_{B,3} that the second device transmits the second acoustic positioning signal is set time t₁ (such as 1 s or 2 s) later than the beginning of the predetermined recording time t₀. The transmitting time of the second acoustic positioning signal is always marked as T_{B,3}, which is not influenced by the preset transmission logic.

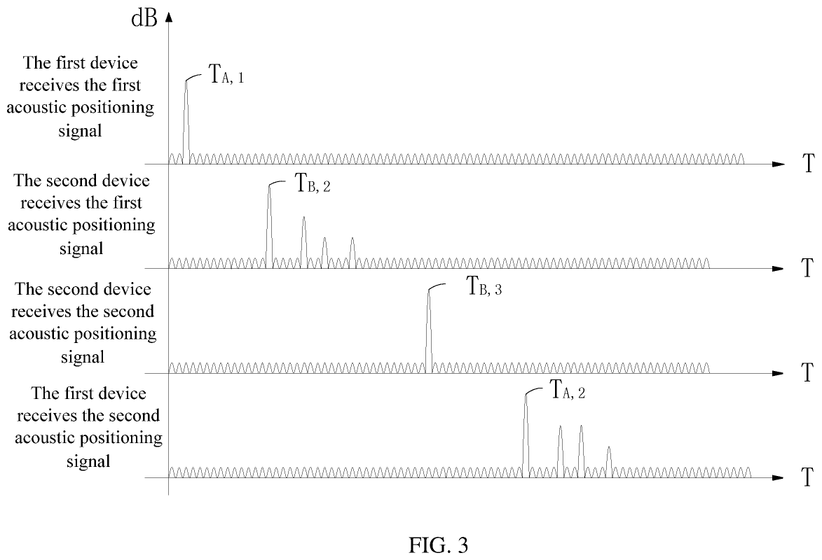

FIG. 3 illustrates a schematic diagram of receiving signals by intelligent devices according to the present application.

Referring to FIG. 3, when the signal processing modules of the first device and the second device calculate the signals, the time of the first peak detected (the direct positioning signal) is selected as the time of detecting the acoustic signal. The corresponding time of the relevant peak position is T_{A,1} (corresponding to the fourth time in FIG. 1), T_{B,2} (corresponding to the second time in FIG. 1), T_{B,3} (corresponding to the first time in FIG. 1) and T_{A,2} (corresponding to the third moment in FIG. 1) respectively. At time T_{A,1}, the first device detects the first acoustic positioning signal. At time T_{B,2}, the second device detects the first acoustic positioning signal. At time T_{B,3}, the second device detects the second acoustic positioning signal. At time T_{A,2}, the first device detects the second acoustic positioning signal.

Based on a sampling point number difference calculated from the recording file of the second device, the difference between the signal receiving time and the signal transmitting time at the second device is calculated. The number difference is recorded as N_{B}, i.e.,

$${T}_{B , 3} - {T}_{B , 2} = \frac{1}{{F}_{S}} * {N}_{B} ,$$

where F_{S} is the sampling frequency of the second device. For example, in a case that the second device detects the first acoustic signal at the 3rd sampling point within the recording duration of its own recording file, and detects the second acoustic signal at the 500th sampling point within the recording duration, the number difference N_{B} is 500−3=497.

Based on a sampling point number difference calculated from the recording file of the first device, the difference between the signal receiving time and the signal transmitting time at the first device is calculated. The number difference is recorded as N_{A}, i.e.,

$${T}_{A , 2} - {T}_{A , 1} = \frac{1}{{F}_{S}} * {N}_{A} ,$$

where F_{S} is the sampling frequency of the first device. For example, in a case that the second device detects the first acoustic signal at the 6th sampling point within the recording duration of its own recording file, and detects the second acoustic signal at the 200th sampling point within the recording duration, the number difference N_{A} is 200−6=194.

The sampling frequency of the first device and the sampling frequency of the second device may be the same or different.

Therefore, the TOF of the signal between the first device and the second device is:

$$T O F = ( {T}_{A , 2} - {T}_{A , 1} ) - ( {T}_{B , 3} - {T}_{B , 2} ) = \frac{1}{{F}_{S}} * ( {N}_{A} - {N}_{B} )$$

The distance between the first device and the second device is:

$$D \approx \frac{1}{2} * c * [ \frac{1}{{F}_{S}} * ( {N}_{A} - {N}_{B} ) ]$$

Description will be made below by giving an example.

It is assumed that the first device (i.e., positioning device) is a mobile phone A, the second device (i.e., positioned device) is a mobile phone B, and the sampling frequency is F_{S}=48000 Hz.

In step 1, a recording duration to =5 s is set (which is adjustable).

In step 2, the mobile phone A transmits a ranging start signal to the mobile phone B through a Bluetooth communication method. At this time, T_{A,0}=0 s. The mobile phone A turns on its microphone and the microphone of the mobile phone A is always in a monitoring and recording state.

In step 3, the mobile phone B receives the ranging start signal and the time T_{B,0}=0.2 s is recorded. The mobile phone B turns on its microphone and the microphone of the mobile phone B is always in a monitoring and recording state.

In step 4, the mobile phone A transmits a first acoustic positioning signal (with frequency of 20 kHz). The first acoustic positioning signal contains a unique identifier of the mobile phone A (such as MAC address). The first acoustic positioning signal is recorded by the microphone of the mobile phone A. The signal processing module of the mobile phone A calculates a corresponding relevant peak position. The time is marked as time T_{A,1}.

In step 5, the mobile phone B receives the first acoustic positioning signal. A signal processing module of the mobile phone B calculates the unique identifier and the relevant peak position in the first acoustic positioning signal. The time is marked as time T_{B,2}.

In step 6, the mobile phone B transmits a second acoustic positioning signal (with frequency of 22 kHz). The second acoustic positioning signal contains a unique identifier of the mobile phone B (such as MAC address). The second acoustic positioning signal is recorded by the microphone of the mobile phone B. The signal processing module of the mobile phone B calculates the relevant peak position in the second acoustic positioning signal. The time is marked as time T_{B,3}. The mobile phone B transmits a difference (T_{B,3}−T_{B,2}) between the signal transmitting time and the signal receiving time t₀ the mobile phone A through a wireless communication method, where N_{B}=45360,

$$( {T}_{B , 3} - {T}_{B , 2} ) = \frac{1}{{F}_{S}} * {N}_{B} = \frac{45360}{48000} = 0.945 s .$$

In step 7, the mobile phone A receives the second acoustic positioning signal, and receives the difference (0.945 s) between the signal receiving time and the signal transmitting time of the mobile phone B. The signal processing module of the mobile phone A calculates the unique identifier and the relevant peak position in the second acoustic positioning signal. The time is marked as time T_{A,2}.

In step 8, the predetermined recording duration of the mobile phone A and the mobile phone B ends, T_{A3}=5 s, T_{B4}=5.2 s.

In step 9, the mobile phone A calculates a distance D between the mobile phone A and the mobile phone B.

$${N}_{A} = 45840 , ( {T}_{A , 2} - {T}_{A , 1} ) = \frac{1}{{F}_{S}} * {N}_{A} = \frac{45840}{48000} \approx 0.955 s ;$$

$$TOF = ( {T}_{A , 2} - {T}_{A , 1} ) - ( {T}_{B , 3} - {T}_{B , 2} ) = 0.01 s ;$$

$$D \approx \frac{1}{2} * c * T O F = 0.5 ⋆ 340 m / s ⋆ 0.01 s = 1.7 m .$$

The embodiment of the present application further provides a ranging apparatus between intelligent devices.

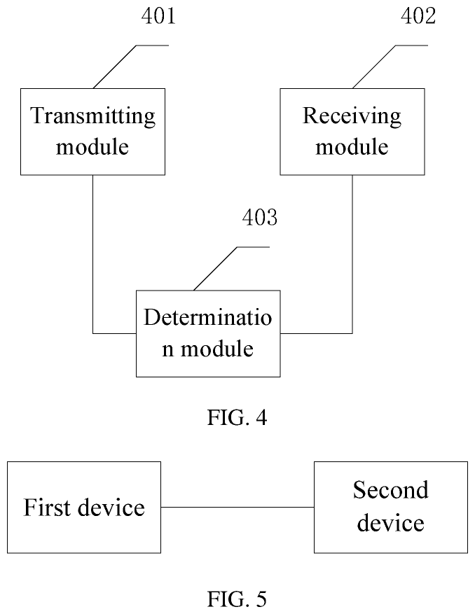

FIG. 4 illustrates an exemplary structural diagram of a ranging apparatus between intelligent devices. Referring to FIG. 4, the ranging apparatus includes a transmitting module 401, a receiving module 402 and a determination module 403.

The transmitting module 401 is configured to transmit a first acoustic positioning signal.

The receiving module 402 is configured to receive the first acoustic positioning signal; receive a notification message containing a first time difference between first time that a second device receives a second acoustic positioning signal and second time that the second device receives the first acoustic positioning signal, wherein the second acoustic positioning signal is transmitted by the second device; and receive the second acoustic positioning signal.

The determination module 403 is configured to determine a second time difference between third time that the first device receives the second acoustic positioning signal and fourth time that the first device receives the first acoustic positioning signal; and determine a distance between the first device and the second device based on the first time difference and the second time difference.

In an embodiment, the transmitting module 401 is further configured to, before transmitting the first acoustic positioning signal, transmit a ranging start signal and enable an acoustic recording function of the first device, so that an acoustic recording function of the second device is enabled when the second device receives the ranging start signal.

In an embodiment, the determination module 403 is further configured to determine the distance D, wherein D≈½*c*(T1−T2), where T1 is the second time difference, T2 is the first time difference and c is sound velocity.

In an embodiment, the second acoustic positioning signal is transmitted by the second device after receiving the first acoustic positioning signal; or the second acoustic positioning signal is transmitted by the second device at a predetermined time point.

The embodiment of the present application further provides a ranging system.

FIG. 5 illustrates an exemplary structural diagram of a ranging system between intelligent devices. The ranging system includes a first device and a second device.

The first device is configured to transmit a first acoustic positioning signal and receive the first acoustic positioning signal.

The second device is configured to receive the first acoustic positioning signal, transmit a second acoustic positioning signal, receive the second acoustic positioning signal, and transmit to the first device a notification message containing a first time difference between first time that the second device receives the second acoustic positioning signal and second time that the second device receives the first acoustic positioning signal. The first device is further configured to receive the second acoustic positioning signal, determine a second time difference between third time that the first device receives the second acoustic positioning signal and fourth time that the first device receives the first acoustic positioning signal, and determine a distance between the first device and the second device based on the first time difference and the second time difference.

The embodiment of the present application further provides an intelligent device. The intelligent device includes a processor and a memory; the memory stores an application program capable of being executed by the processor to enable the processor to execute the ranging method. The intelligent device may be implemented as a smart phone, a smart speaker, a tablet, a smart watch, a smart television, etc.

The embodiment of the present application further provides a computer-readable storage medium. The computer-readable storage medium stores a computer program, which, when executed by a processor, implements each process implemented in each embodiment of the present application, thus achieving the same technical effect. In order to avoid repetition, it is not repeated here. The computer-readable storage medium may be, for example, a Read-Only Memory (ROM), a Random Access Memory (RAM), a magnetic disk or an optical disk. Through the description of the above embodiments, those skilled in the art can clearly understand that the method in the embodiments can be implemented by means of software and necessary general hardware platform, and of course, can also be implemented by means of hardware, but in many cases the former is preferred. Based on this understanding, the technical solution of the present application, or the part that contributes to the existing technology, can be embodied in the form of a software product, which is stored in a storage medium (such as ROM/RAM, magnetic disk, or optical disk), and includes several instructions used for enabling a terminal (which may be a mobile phone, computer, server, air conditioner, or network device) to execute the method described in each embodiment of the present application.

The embodiments of the present application are described above with reference to the drawings, but the present application is not limited to the specific embodiments described above. The specific embodiments described above are only exemplary, not restrictive. Under the enlightenment of the present application, those skilled in the art may make many variations without departing from the essence of the present application and the scope set forth in the claims, all of which are within the scope of protection of the present application.

1. A ranging method, wherein the ranging method is applicable to a first device and the ranging method comprises:
transmitting a first acoustic positioning signal;
receiving the first acoustic positioning signal;
receiving a notification message containing a first time difference between first time that a second device receives a second acoustic positioning signal and second time that the second device receives the first acoustic positioning signal, the second acoustic positioning signal being transmitted by the second device;
receiving the second acoustic positioning signal;
determining a second time difference between third time that the first device receives the second acoustic positioning signal and fourth time that the first device receives the first acoustic positioning signal; and
determining a distance between the first device and the second device based on the first time difference and the second time difference.

2. The ranging method according to claim 1, wherein the ranging method further comprises:
before the step of transmitting the first acoustic positioning signal, transmitting a ranging start signal and enabling an acoustic recording function of the first device, so that an acoustic recording function of the second device is enabled when the second device receives the ranging start signal.

3. The ranging method according to claim 2, wherein the ranging method further comprises:
determining the first time difference based on a point number difference between a sampling point that the second device receives the second acoustic positioning signal in a recording file generated by the acoustic recording function of the second device and a sampling point that the second device receives the first acoustic positioning signal in the recording file generated by the acoustic recording function of the second device, and a predetermined sampling frequency; and
determining the second time difference based on a point number difference between a sampling point that the first device receives the second acoustic positioning signal in a recording file generated by the acoustic recording function of the first device and a sampling point that the first device receives the first acoustic positioning signal in the recording file generated by the acoustic recording function of the first device, and a predetermined sampling frequency.

4. The ranging method according to claim 1, wherein
the second acoustic positioning signal is transmitted by the second device after receiving the first acoustic positioning signal; or
the second acoustic positioning signal is transmitted by the second device at a predetermined time point.

5. The ranging method according to claim 1, wherein
the step of determining a distance between the first device and the second device based on the first time difference and the second time difference comprises:
determining the distance D, wherein D≈½*c*(T1−T2), where T1 is the second time difference, T2 is the first time difference and c is sound velocity.

6. A ranging apparatus, wherein the ranging apparatus is contained in a first device and the ranging apparatus comprises:
a transmitting module configured to transmit a first acoustic positioning signal;
a receiving module configured to receive the first acoustic positioning signal; receive a notification message containing a first time difference between first time that a second device receives a second acoustic positioning signal and second time that the second device receives the first acoustic positioning signal, the second acoustic positioning signal being transmitted by the second device; and receive the second acoustic positioning signal; and
a determination module configured to determine a second time difference between third time that the first device receives the second acoustic positioning signal and fourth time that the first device receives the first acoustic positioning signal; and determine a distance between the first device and the second device based on the first time difference and the second time difference.

7. The ranging apparatus according to claim 6, wherein
the transmitting module is further configured to, before transmitting the first acoustic positioning signal, transmit a ranging start signal and enable an acoustic recording function of the first device, so that an acoustic recording function of the second device is enabled when the second device receives the ranging start signal; and/or
the determination module is further configured to determine the distance D, wherein D≈½*c*(T1−T2), where T1 is the second time difference, T2 is the first time difference and c is sound velocity.

8. A ranging system, wherein the ranging system comprises:
a first device configured to transmit a first acoustic positioning signal and receive the first acoustic positioning signal; and
a second device configured to receive the first acoustic positioning signal, transmit a second acoustic positioning signal, receive the second acoustic positioning signal, and transmit to the first device a notification message containing a first time difference between first time that the second device receives the second acoustic positioning signal and second time that the second device receives the first acoustic positioning signal, wherein
the first device is further configured to receive the second acoustic positioning signal, determine a second time difference between third time that the first device receives the second acoustic positioning signal and fourth time that the first device receives the first acoustic positioning signal, and determine a distance between the first device and the second device based on the first time difference and the second time difference.

9. An intelligent device, wherein the intelligent device comprises a processor and a memory;
the memory stores an application program capable of being executed by the processor to enable the processor to execute the ranging method according to claim 1.

10. A computer-readable storage medium, wherein the computer-readable storage medium stores a computer program, which, when executed by a processor, implements the ranging method according to claim 1.

11. The ranging method according to claim 2, wherein
the step of determining a distance between the first device and the second device based on the first time difference and the second time difference comprises:
determining the distance D, wherein D≈½*c*(T1−T2), where T1 is the second time difference, T2 is the first time difference and c is sound velocity.

12. The ranging method according to claim 3, wherein
the step of determining a distance between the first device and the second device based on the first time difference and the second time difference comprises:
determining the distance D, wherein D≈½*c*(T1−T2), where T1 is the second time difference, T2 is the first time difference and c is sound velocity.

13. The ranging method according to claim 4, wherein
the step of determining a distance between the first device and the second device based on the first time difference and the second time difference comprises:
determining the distance D, wherein D≈½*c*(T1−T2), where T1 is the second time difference, T2 is the first time difference and c is sound velocity.

14. An intelligent device, wherein the intelligent device comprises a processor and a memory;
the memory stores an application program capable of being executed by the processor to enable the processor to execute the ranging method according to claim 2.

15. An intelligent device, wherein the intelligent device comprises a processor and a memory;
the memory stores an application program capable of being executed by the processor to enable the processor to execute the ranging method according to claim 3.

16. An intelligent device, wherein the intelligent device comprises a processor and a memory;
the memory stores an application program capable of being executed by the processor to enable the processor to execute the ranging method according to claim 4.

17. An intelligent device, wherein the intelligent device comprises a processor and a memory;
the memory stores an application program capable of being executed by the processor to enable the processor to execute the ranging method according to claim 5.

18. A computer-readable storage medium, wherein the computer-readable storage medium stores a computer program, which, when executed by a processor, implements the ranging method according to claim 2.

19. A computer-readable storage medium, wherein the computer-readable storage medium stores a computer program, which, when executed by a processor, implements the ranging method according to claim 3.

20. A computer-readable storage medium, wherein the computer-readable storage medium stores a computer program, which, when executed by a processor, implements the ranging method according to claim 4.

21. A computer-readable storage medium, wherein the computer-readable storage medium stores a computer program, which, when executed by a processor, implements the ranging method according to claim 5.
